(19) United States
(12) Patent Application Publication
(10) Pub. No.: US 2006/0163901 A1
(43) Pub. Date: Jul. 27, 2006

(54) Sunvisor for a vehicle

(75) Inventor: Shiroh Hiraga, Toyota-shi (JP)

Correspondence Address: CONLEY ROSE, P.C., P. O. BOX 3267, HOUSTON, TX, 77253-3267, US

(73) Assignees: Kyowa Sangyo Co., LTD, Toyota-shi (JP); Shinwa Seiko Co., LTD., Toyota-shi (JP)

(21) Appl. No.: 11/291,215

(22) Filed: Dec. 1, 2005

(30) Foreign Application Priority Data
Jan. 21, 2005 (JP) 2005-014192

(51) Int. Cl. B60J 3/02

(52) U.S. Cl. 296/97.9

(57) ABSTRACT

A sunvisor for a vehicle has a support shaft inserted into a visor body and a retention device. The support shaft rotatably supports the visor body around the support shaft. The retention device inhibits the visor body from slipping-off from the support shaft. The retention device has one or more engaging members that are pivotably mounted in the visor body. The one or more engaging members have an engaging portion. When the visor body moves in the direction of slipping-off of the support shaft, at least one of the engaging members is pressed by the support and is pivoted. The engaging portion then engages with a locking portion formed at the support shaft.

This application claims priority to Japanese patent application serial number 2005-14192, the contents of which are incorporated herein by reference.

### BACKGROUND OF THE INVENTION

1. Field of the Invention

The present invention relates to a sunvisor for a vehicle that has a support shaft inserted into a visor body and a retention device. The support shaft supports the visor body rotatably around the support shaft. The retention device inhibits the visor body from slipping-off of the support shaft in the axial direction.

2. Description of the Related Art

A sunvisor for a vehicle generally has a retention device to inhibit the visor body from slipping-off of the support shaft in the axial direction. For example, the sunvisor for a vehicle described in JP 2003-127662 A has a clip inside of the visor body to bias the visor body to the cabin ceiling surface. The retention device is provided between the clip and the support shaft. The retention device has locking claws that are formed on the clip. A groove portion is formed on the outer peripheral surface of the support shaft. The locking claws slidably engage the groove portion.

In this regard, many recent vehicles have air bags installed in the cabin-ceiling surface. Accordingly, the visor body may be pushed by the air bags when the air bags deploy. The air bags cause the visor body to be pushed axially with respect to the support shaft (see FIG. 1). Accordingly, in recent years, there has been an increasingly strong demand for a retention device capable of securely inhibiting the visor body from slipping-off of the support shaft in an axial direction.

### SUMMARY OF THE INVENTION

It is accordingly an object of the present invention to provide a sunvisor for a vehicle that is equipped with a retention device capable of securely inhibiting the visor body from slipping-off of the support shaft in an axial direction.

According to one aspect of the present teachings, a retention device has one or more engaging members mounted in the visor body. Each of the one or more engaging members has an engaging portion. The support shaft has a locking portion. When the visor body moves in a slipping-off direction of the support shaft, the one or more engaging members interact with the support shaft and are manipulated so that the engaging portion of at least one of the one or more engaging members engages with the locking portion. Therefore, the retention device can inhibit the visor body from slipping-off of the support shaft.

In another aspect of the present teachings, at least one of the one or more engaging members is pivotably mounted in the visor body. When the visor body moves in the slipping-off direction of the support shaft, the at least one of the one or more engaging members interacts with the support shaft and is pivoted so that the engaging portion of the at least one of the one or more engaging members engages with the locking portion.

In another aspect of the present teachings, at least one of the one or more engaging members has a fixed end fixed and is configured in a cantilever manner. When the visor body moves in the slipping-off direction of the support shaft, the at least one of the engaging members interacts with the support shaft and is deformed so that the engaging portion of the at least one of the one or more engaging members engages with the locking portion.

In another aspect of the present teachings, a retention device has one or more engaging members whose end is fixed in the visor body. The one or more engaging members have an engaging portion. When the visor body moves in the direction of slipping-off of the support shaft, at least one of the engaging members are pressed by the support shaft so as to be deformed. The engaging portion then engages with a locking portion formed at the support shaft. Therefore, the retention device can prevent the visor body from slipping-off of the support shaft.

In another aspect of the present teachings, at least one of the engaging portion or the locking portion has an inclined surface formed therein, so that as the visor body moves in the slipping-off direction of the support shaft the engaging portion is urged in a direction of further engagement with the locking portion. Accordingly, the engaging portion firmly engages with the locking portion due to the inclined surface. This makes it possible to securely inhibit the slipping-off of the visor body from the support shaft.

In another aspect of the present teachings, a retention device has one or more engaging members mounted on the support shaft. Each of the one or more engaging members has an engaging portion. The visor body has a locking portion. When the visor body moves in the slipping-off direction of the support shaft the one or more engaging members interact with the visor body and are manipulated so that the engaging portion of at least one of the one or more engaging members engages with the locking portion. Therefore, the retention device can prevent the visor body from slipping-off of the support shaft.

In another aspect of the present teachings, at least one of the one or more engaging members is pivotably mounted on the support shaft. When the visor body moves in the slipping-off direction of the support shaft, the at the least one of the one or more engaging members interacts with the visor body and is pivoted so that the engaging portion of the at least one of the one or more engaging members engages with the locking portion.

In another aspect of the present teachings, at least one of the one or more engaging members has a fixed end fixed and is configured in a cantilever manner. When the visor body moves in the slipping-off direction of the support shaft, the at least one of the one or more engaging members interacts with the visor body and is deformed so that the engaging portion of the at least one of the engaging members engages with the locking portion.

In another aspect of the present teachings, at least one of the engaging portion or the locking portion has an inclined surface formed therein, so that as the visor body moves in the slipping-off direction of the support shaft the engaging portion is urged in a direction of further engagement with the locking portion. This makes it possible to securely inhibit the slipping-off of the visor body from the support shaft.

### BRIEF DESCRIPTION OF THE DRAWINGS

FIG. 1 is a perspective view of a sunvisor for a vehicle of a first representative embodiment; and

FIG. 2 is an expanded view of the sunvisor of a first representative embodiment near a retention device in condition of carrying away one of shelves; and

FIG. 3 is a perspective view of a engaging member of a first representative embodiment; and

FIG. 4 is a cross-sectional view taken along line IV-IV in FIG. 2; and

FIG. 5 is a front expanded view of the sunvisor of a first representative embodiment near the retention device, equivalent to FIG. 2, to show the insertion of the support shaft into the visor body; and

FIG. 6 is a front expanded view of the sunvisor near the retention device, equivalent to FIG. 2, to show the insertion of the support shaft into the visor body; and

FIG. 7 is a front expanded view of the sunvisor near the retention device, equivalent to FIG. 2, to show the retention device behavior when the visor body is forced in the slipping-off direction of the support shaft; and

FIG. 8 is a perspective view of the engaging member of a second representative embodiment; and

FIG. 9 is an expanded view of the sunvisor of a third representative embodiment near a retention device equivalent to FIG. 2; and

FIG. 10 is an expanded view of the sunvisor of a fourth representative embodiment near a retention device equivalent to FIG. 2.

### DETAILED DESCRIPTION OF THE INVENTION

Each of the additional features and teachings disclosed above and below may be utilized separately or in conjunction with other features and teachings to provide improved sunvisors for a vehicle. Representative examples of the present invention, which examples utilize many of these additional features and teachings both separately and in conjunction with one another, will now be described in detail with reference to the attached drawings. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples of the invention. Moreover, various features of the representative examples and the dependent claims may be combined in ways that are not specifically enumerated in order to provide additional useful embodiments of the present teachings.

### First Representative Embodiment

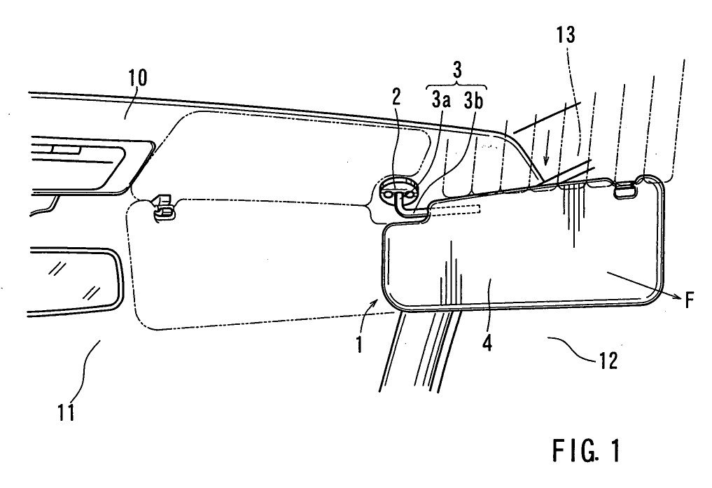

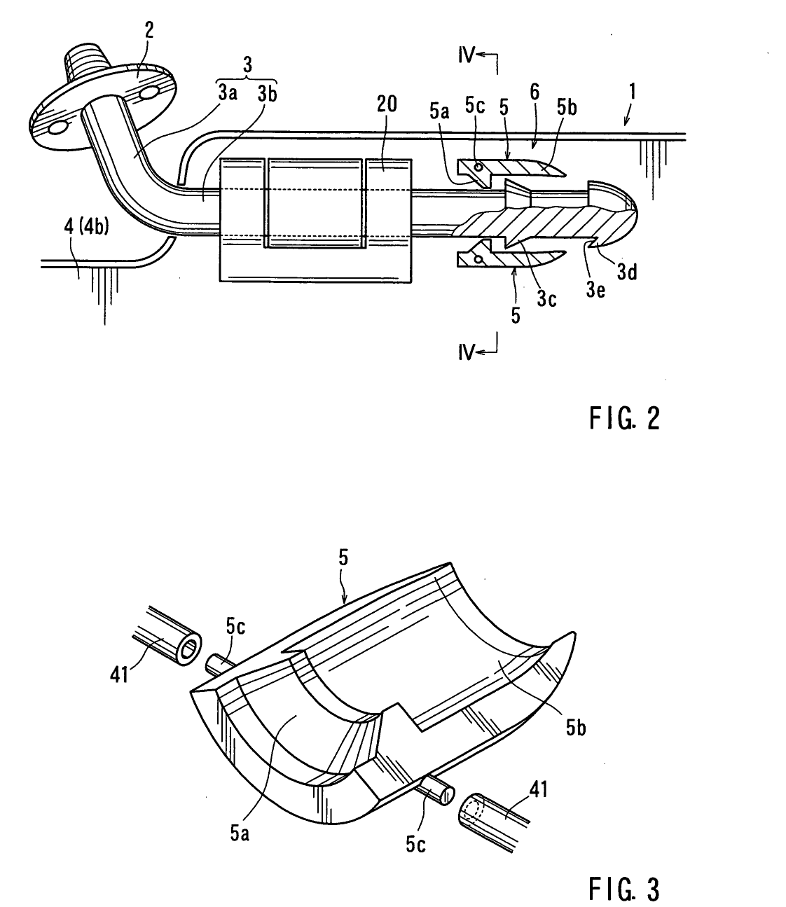

A first representative embodiment of the present invention will now be described with reference to FIGS. 1 to 7. As shown in FIG. 1, a vehicle sunvisor 1 has a plate-shaped visor body 4, a support shaft 3, and a bracket 2. The support shaft 3 is inserted into the visor body 4 and supports the visor body 4 such that the visor body 4 is rotatable around the support shaft 3. The bracket 2 mounts the support shaft 3 to a cabin-ceiling surface 10. Further, as shown in FIG. 2, a retention device 6 is provided in the visor body 4 to inhibit the visor body 4 from slipping-off of the support shaft 3 in the axial direction.

As shown in FIG. 2, the support shaft 3 is formed in a substantially L-shaped configuration, and has a vertical shaft 3a and a horizontal shaft 3b. The horizontal shaft 3b is rotatably inserted in a bearing member 20 provided at the upper end edge of the visor body 4, thus rotatably supporting the visor body 4. The vertical shaft 3a is mounted to the cabin-ceiling surface 10 through the bracket 2 so as to be rotatable around the vertical shaft 3a.

Thus, as shown in FIG. 1, by being rotated about the horizontal shaft 3b, the visor body 4 is rotated between a light shielding position and a storage position where it is positioned along the cabin-ceiling surface 10. Further, by being rotated about the vertical shaft 3a together with the support shaft 3, the visor body 4 is rotated between the light shielding position where it is positioned along the glass surface of a windshield 11 and a side position where it is positioned along the glass surface of a side glass 12.

As shown in FIG. 2, the retention device 6 is provided between the visor body 4 and the support shaft 3. The retention device 6 has two engaging members 5 mounted to the visor body 4.

As shown in FIG. 3, each engaging member 5 has a half cylinder-type configuration with a tapered distal end portion (i.e., right-hand side portion). The engaging member 5 has an engaging portion 5b, a force receiving portion 5a, and a pair of pivot shafts 5c. The engaging portion 5b is formed at a distal end portion of the engaging member 5, and engages with the support shaft 3. The force receiving portion 5a is formed on an inner peripheral surface of the engaging member 5 extending on the axial center side and has a half disc-shaped configuration. The pair of pivot shafts 5c is formed on an outer peripheral surface of the engaging member 5.

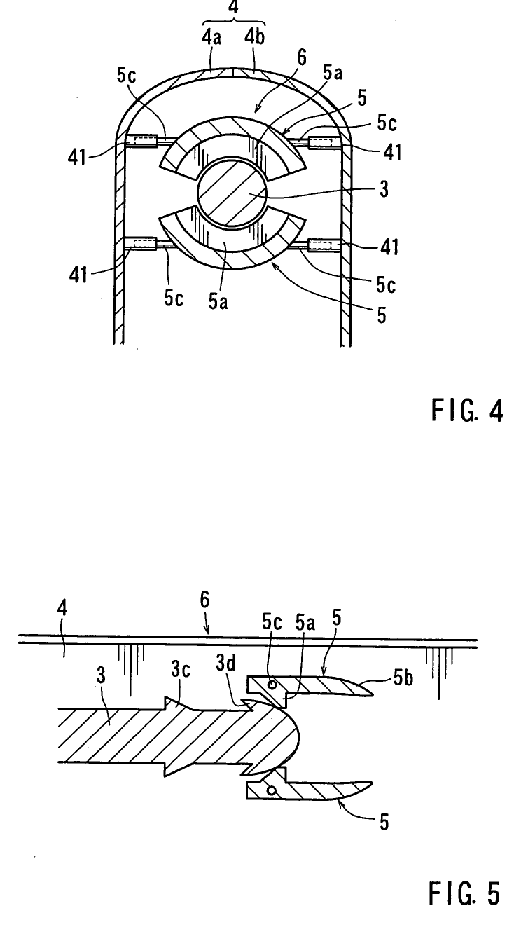

As shown in FIG. 4, the visor body 4 has a pair of shell members, 4a and 4b, stacked in the thickness direction. Each of the shell members, 4a and 4b, has a boss 41 to which the pivot shaft 5c of each engaging member 5 is pivotably attached. Accordingly, the engaging member 5 is pivotably mounted with respect to the visor body 4.

As shown in FIG. 2, the support shaft 3 has a locking portion 3d and a pressing portion 3c. The locking portion 3d is formed at the distal end of the horizontal shaft 3b so as to be radially enlarged. The locking portion 3d is arranged at a position past the engaging member 5 (i.e., a position on the right-hand side of FIG. 2). And as shown in FIG. 7, the engaging portion 5b of the engaging member 5 is brought into locking engagement with the locking portion 3d. The locking portion 3d has an inclined surface 3e for urging the engaging portion 5b into engagement therewith at a time of engagement with the engaging portion 5b.

As also shown in FIG. 2, the pressing portion 3c is formed near the distal end portion of the horizontal shaft 3b, so as to be radially enlarged, and protrudes laterally from the outer peripheral surface of the horizontal shaft 3b. The pressing portion 3c is arranged at a position past the force receiving portion 5a of the engaging member 5 (i.e., a position on the right-hand side of FIG. 2). And as shown in FIG. 7, the force receiving portion 5a can press the pressing portion 3c.

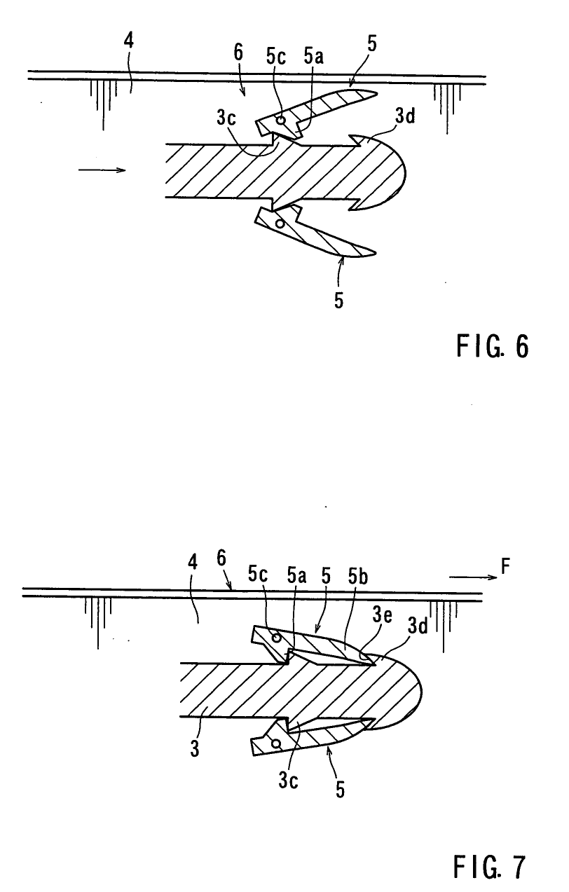

A method of assembling together the support shaft 3 and the visor body 4 will be described below. As shown in FIG. 5, when the support shaft 3 is inserted into the visor body 4, the distal end portion of the support shaft 3 comes into abutment with the force receiving portions 5a of the engaging members 5. When the support shaft 3 is inserted further in this state, the support shaft 3 is inserted in between the pair of engaging members 5 while pressing the force receiving portions 5a at their distal end portions. As the support shaft 3 is inserted even further, as shown in FIG. 6, the support shaft 3 is inserted in between the pair of engaging members 5 with the pressing portion 3c of the support shaft 3 pressing the force receiving portion 5a of the engaging members 5, thereby pivoting the engaging members 5. The support shaft 3 is therefore inserted to the position shown in FIG. 2.

Incidentally, the visor body 4 is often applied with a force acting in a direction for slipping-off of the support shaft 3. For example as shown in FIG. 1, when the visor body 4 is rotated to the side position and an air bag 13 (e.g., a roof-side air bag) provided in the cabin ceiling surface 10 is deployed, the visor body 4 is applied with a force F acting in the direction of slipping-off the visor body 4 from the support shaft 3.

Herein below, a description will be made of the action of the retention device 6 when a force acting in the direction of slipping-off the visor body 4 from the support shaft 3 is applied to the visor body 4.

As shown in FIG. 7, when the force F acting in the direction of slipping-off of the support shaft 3 is applied to the visor body 4, the engaging members 5 move together with the visor body 4 in the direction of slipping-off of the support shaft 3. The force receiving portions 5a of the engaging members 5 are then pressed by the pressing portion 3c formed in the support shaft 3. As a result, the engaging members 5 pivot about their respective pivot shafts 5c, and the engaging portions 5b of the engaging members 5 come into engagement with the locking portion 3d of the support shaft 3.

Further, as the force acting in the direction of slipping-off of the support shaft 3 continues to be applied to the visor body 4, the force receiving portions 5a are more firmly pressed by the pressing portion 3c, causing the engaging members 5 to pivot still further. The engaging portions 5d are then even more firmly engaged with the locking portion 3d.

In addition, the engaging portions 5b are guided toward the center axis of the support shaft 3 due to the inclined surface 3e formed in the locking portion 3d. The engaging portions 5b are thus applied with forces acting in the direction of bringing the engaging portions 5b into engagement with the locking portion 3d. This brings the engaging portions 5b into firm engagement with the locking portion 3d.

The first representative embodiment of the present invention is formed as described above. That is, as shown in FIG. 7, the retention device 6 has one or more engaging members 5. When the visor body 4 moves in the direction of slipping-off of the support shaft 3, the one or more engaging members 5 are pressed by the support shaft 3 so as to be rotated into engagement with the support shaft 3. Therefore, the retention device 6 can prevent the visor body 4 from slipping-off of the support shaft 3.

Additionally, each of the one or more engaging members S have an engaging portion 5b, which is pivoted into engagement with the support shaft 3 as the visor body 4 moves in the direction of slipping-off of the support shaft 3. Accordingly, the one or more engaging members 5 are brought into firm engagement with the support shaft 3 by utilizing the force acting in the direction of slipping-off of the support shaft 3. The slipping-off of the visor body 4 from the support shaft 3 can thus be securely inhibited.

Still further, as shown in FIG. 2, the locking portion 3d has an inclined surface 3e for imparting a force acting in the direction of bringing the engaging portion 5b into engagement with the locking portion 3d, as the visor body 4 moves in a direction of detachment from the support shaft 3.

Accordingly, the engaging portion 5b is brought into firm engagement with the locking portion 3d due to the inclined surface 3e. This makes it possible to securely inhibit the slipping-off of the visor body 4 from the support shaft 3.

### Second Representative Embodiment

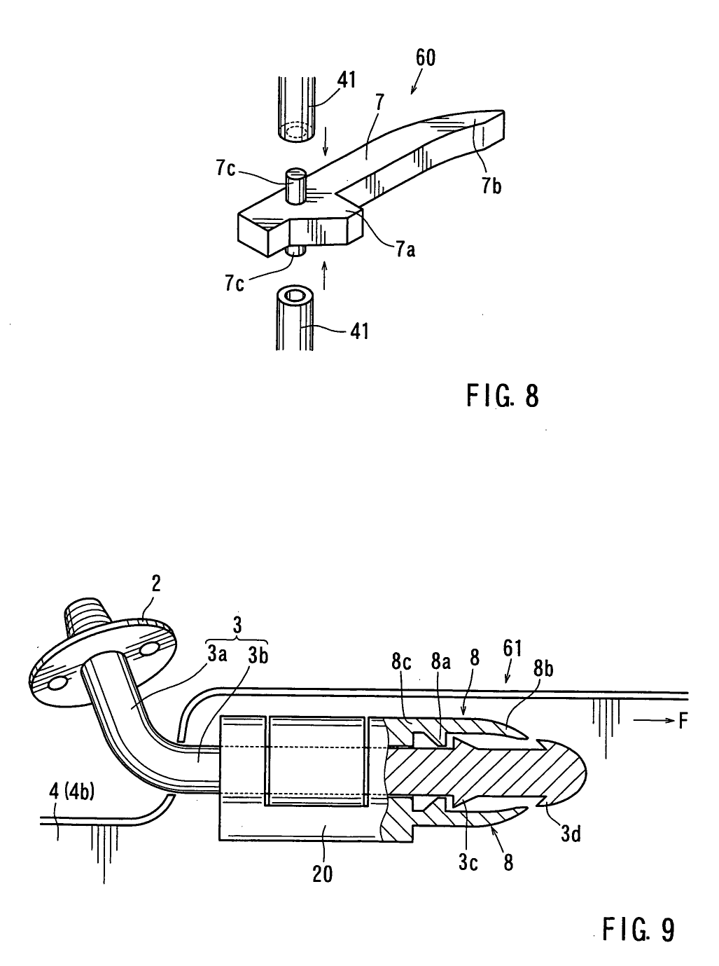

The second representative embodiment of the present invention will be described with reference to FIG. 8. The second representative embodiment is constructed in substantially the same manner as in the first representative embodiment. However, a retention device 60 of the second representative embodiment has engaging members 7 as shown in FIG. 8 instead of the engaging members 5 shown in FIG. 3. Herein below, the second representative embodiment will be described with a focus on the differences from the first embodiment.

As shown in FIG. 8, each engaging member 7 is formed in a crescent shape and has an engaging portion 7b at its distal end portion (i.e., right-hand side portion as viewed in FIG. 8). The engaging member 7 has a pair of pivot shafts 7c protruding from the front and back surfaces at a base end portion thereof. A force receiving portion 7a protrudes from the inner peripheral edge thereof. Each of pivot shafts 7c is rotatably mounted to a boss 41 formed in each respective shell member of the visor body.

The retention device 60 exhibits the same operation and effect as the retention device 6 of the first representative embodiment, and thus inhibits the axial slipping-off of the visor body 4 from the support shaft 3.

### Third Representative Embodiment

The third representative embodiment of the present invention will be described with reference to FIG. 9. The third representative embodiment is constructed in substantially the same manner as in the first representative embodiment. However, a retention device 61 of the third representative embodiment has engaging members 8, as shown in FIG. 9, instead of the engaging members 5 shown in FIG. 3. Herein below, the third representative embodiment will be described with a focus on the differences from the first representative embodiment.

As shown in FIG. 9, each of the engaging members 8 has a base end portion 8c fixed to the bearing member 20, and extends in a cantilever manner toward the distal end of the support shaft 3. Additionally, each of the engaging members 8 has an engaging portion 8b at the distal end portion, and a force receiving portion 8a protruding from an inner peripheral surface thereof.

When the visor body 4 is applied with a force F in the direction of slipping-off of the support shaft 3, the force receiving portion 8a of the each engaging member 8 is pressed by the pressing portion 3c formed in the support shaft 3. Accordingly, each engaging member 8 elastically deforms about the base end portion 8c. The engaging portion 8b of each engaging member 8 engages with the locking portion 3d of the support shaft 3. Therefore, the retention device 61 can prevent the visor body 4 from slipping-off of the support shaft 3.

### Fourth Representative Embodiment

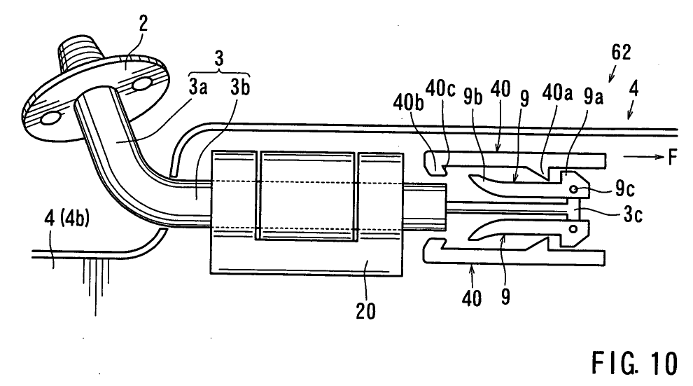

The fourth representative embodiment of the present invention will be described with reference to FIG. 10. The fourth representative embodiment is constructed in substantially the same manner as in the first representative embodiment. However, as shown in FIG. 10 the fourth representative embodiment differs from the first representative embodiment in that a retention device 62 of the fourth representative embodiment has a pair of engaging members 9 provided by the support shaft 3, and a pair of locking members 40 provided on the side of the visor body 4. Herein below, the fourth representative embodiment will be described with a focus on the differences from the first representative embodiment.

As shown in FIG. 10, each engaging member 9 has a pivot shaft 9c pivotably attached to the distal end of the support shaft 3. In addition, each engaging member 9 extends from the distal end side of the support shaft 3 toward the base end side of the support shaft 3. Further, each engaging member 9 has an engaging portion 9b at an extending tip end portion. In the vicinity of the pivot shaft 9c, each engaging member 9 has a force receiving portion 9a respectively projecting toward the corresponding locking member 40.

The locking members 40 are mounted integrally or separately on the inner peripheral surfaces of the visor body 4. Each locking member 40 extends along the horizontal shaft 3b of the support shaft 3. In addition, each locking member 40 has a pressing portion 40a and a locking portion 40b that project toward the engaging member 9. Still further, each locking portion 40b has an inclined surface 40c for urging the corresponding engaging portion 9b in the engaging direction when the locking portion 40b is engaged with the engaging portion 9b.

Herein below, a description will be made of the actions of the retention device 62 when the visor body 4 is applied with a force acting in the direction of slipping-off of the support shaft 3.

When the visor body 4 is applied with a force F in the direction of slipping-off of the support shaft 3, the locking members 40 move together with the visor body 4 in the direction of slipping-off of the support shaft 3. This causes each pressing portion 40a of the each locking member 40 to press the force receiving portions 9a of the locking members 9 so that each engaging member 9 pivots about their respective pivot shafts 9c. Each engaging portion 9b of each engaging member 9 then comes into engagement with each corresponding locking member 40.

The fourth representative embodiment is constructed as described above. That is, as shown in FIG. 10 the retention device 62 has one or more engaging members 9 pivotably mounted on the side of the support shaft 3. In addition, when the visor body 4 moves in the direction of slipping-off of the support shaft 3, the one or more engaging members 9 are pressed to pivot by each of the pressing portion 40a formed on the visor body 4 side. Thereby, the one or more engaging members 9 come into engagement with each corresponding locking portion 40b formed on the visor body 4 side. Therefore, the retention device 62 can inhibit visor body 4 from slipping-off of the support shaft 3.

Still further, each engaging member 9 has an engaging portion 9b that is pivoted into engagement with the visor body 4 as the visor body 4 moves in the direction of slipping-off of the support shaft 3. Each engaging member 9 is thus brought into firm engagement with the visor body 4 by utilizing the force acting in the direction of slipping-off of the support shaft 3. Therefore, the slipping-off of the visor body 4 from the support shaft 3 can be securely inhibited.

### Other Possible Embodiments

The present invention may not be limited to the first through fourth representative embodiments, which are presented only as examples of the teachings of the invention. In addition, the invention can be configured as the following embodiments among others, such as, combinations of various components of the embodiments for example.

(1) The engaging members according to the fourth representative embodiment are pivotably mounted onto the support shaft (see FIG. 10). However, a construction is also possible in which the engaging members are fixed to the support shaft in a cantilever manner. The engaging members undergo elastic deformation by being pressed by the pressing portion formed on the visor body side as the visor body moves in the direction causing the slipping-out of the support shaft. The slipping-off preventing members have an engaging portion that is brought into engagement due to the elastic deformation with the locking portions formed on the visor body side.

(2) Further, in each of the first through fourth representative embodiments, the inclined surface, which applies the force acting to bring the engaging portions into engagement with the locking portions, is provided on the engaging portion side. However, the inclined surfaces may be provided on the locking portion side.

(3) In addition, the pair of engaging members of the first and second representative embodiments is mounted to the visor body. However, to unitize the pair of engaging members, a holding member may be provided to pivotably hold the pair of engaging members, with those components being integrally mounted to the visor body.

(4) Further, the visor body of the first through the fourth representative embodiments is a hollow shell member. However, the visor body may be a solid one composed of expanded polystyrene or the like.

1. A sunvisor for a vehicle comprising:
a support shaft inserted into a visor body and supporting the visor body so that the visor body is rotatable around the support shaft; and
a retention device arranged and constructed to inhibit the visor body from slipping-off of the support shaft;
wherein the retention device has one or more engaging members mounted in the visor body; and
wherein each of the one or more engaging members has an engaging portion; and
wherein the support shaft has a locking portion;
wherein as the visor body moves in a slipping-off direction of the support shaft, the one or more engaging members interact with the support shaft and are manipulated so that the engaging portion of at least one of the one or more engaging members engages with the locking portion.

2. The sunvisor for a vehicle as in claim 1,
wherein at least one of the one or more engaging members is pivotably mounted in the visor body;
wherein as the visor body moves in the slipping-off direction of the support shaft, the at least one of the one or more engaging members interacts with the support shaft and is pivoted so that the engaging portion of the at least one of the one or more engaging members engages with the locking portion.

3. The sunvisor for a vehicle as in claim 1,
wherein at least one of the one or more engaging members has a fixed end fixed relative to the visor body and is configured in a cantilever manner;
wherein as the visor body moves in the slipping-off direction of the support shaft, the at least one of the engaging members interacts with the support shaft and is deformed so that the engaging portion of the at least one of the one or more engaging members engages with the locking portion.

4. The sunvisor for a vehicle as in claim 1,
wherein at least one of the engaging portion or the locking portion has an inclined surface formed therein, so that as the visor body moves in the slipping-off direction of the support shaft the engaging portion is urged in a direction of further engagement with the locking portion.

5. A sunvisor for a vehicle comprising:
a support shaft inserted into a visor body and rotatably supporting the visor body at least about the support shaft; and
a retention device arranged and constructed to prevent the visor body from slipping-off of the support shaft;
wherein the retention device has one or more engaging members mounted on the support shaft; and
wherein each of the one or more engaging members has an engaging portion; and
wherein the visor body has a locking portion;
wherein as the visor body moves in the slipping-off direction of the support shaft, the one or more engaging members interact with the visor body and are manipulated so that the engaging portion of at least one of the one or more engaging members engages with the locking portion.

6. The sunvisor for a vehicle as in claim 5,
wherein at least one of the one or more engaging members is pivotably mounted on the support shaft;
wherein as the visor body moves in the slipping-off direction of the support shaft, the at the least one of the one or more engaging members interacts with the visor body and is pivoted so that the engaging portion of the at least one of the one or more engaging members engages with the locking portion.

7. The sunvisor for a vehicle as in claim 5,
wherein at least one of the one or more engaging members has a fixed end fixed relative to the support shaft and is configured in a cantilever manner;
wherein as the visor body moves in the slipping-off direction of the support shaft, the at least one of the one or more engaging members interacts with the visor body and is deformed so that the engaging portion of the at least one of the engaging members engages with the locking portion.

8. The sunvisor for a vehicle as in claim 5,
wherein at least one of the engaging portion or the locking portion has an inclined surface formed therein, so that as the visor body moves in the slipping-off direction of the support shaft the engaging portion is urged in a direction of further engagement with the locking portion.
